(19) United States
(12) Patent Application Publication
(10) Pub. No.: US 2025/0271842 A1
(43) Pub. Date: Aug. 28, 2025

(54) APPARATUS

(71) Applicant: TOYOTA JIDOSHA KABUSHIKI KAISHA, Toyota-shi (JP)

(72) Inventors: Kento IWAHORI, Nagoya-shi (JP); Daiki YOKOYAMA, Miyoshi-shi (JP); Jyunya KATOU, Toyota-shi (JP); Kosei MINAMI, Toyota-shi (JP); Yasuhiro SAITO, Toyoake-shi (JP)

(73) Assignee: TOYOTA JIDOSHA KABUSHIKI KAISHA, Toyota-shi (JP)

(21) Appl. No.: 19/046,093

(22) Filed: Feb. 5, 2025

(30) Foreign Application Priority Data
Feb. 28, 2024 (JP) 2024-028015

(51) Int. Cl. G05B 19/418; G05D 1/221; G05D 107/70; G05D 109/10

(52) U.S. Cl. CPC G05B 19/41875; G05D 1/221; G05D 2107/70; G05D 2109/10

(57) ABSTRACT

An apparatus comprising: a first acquisition unit acquiring first information, the first information being unique information of a moving object, the moving object being capable of moving by unmanned driving; a second acquisition acquiring second information, the second information being unique information of a part to be assembled to the moving object; and a determination unit determining whether correspondence relationship between the moving object and the part is correct based on the first information and the second information.

### CROSS REFERENCE TO RELATED APPLICATIONS

This application claims priority from Japanese Patent Application No. 2024-28015, filed Feb. 28, 2024, the disclosure of which is incorporated herein by reference in its entirety.

### BACKGROUND

### Field

The present disclosure relates to an apparatus.

### Related Art

Japanese Patent Application Publication (Translation of PCT Application) No. 2017-538619 discloses a technique of causing a vehicle to run by unmanned driving in a manufacturing process of the vehicle.

When a part is assembled to a moving object such as a vehicle in a manufacturing process of the moving object, the part corresponding to the moving object needs to be assembled to the moving object. However, the technique to confirm correspondence relationship between the moving object and the part when unmanned driving is used in the manufacturing process has not been explored.

### SUMMARY

The present disclosure is feasible in the following aspects.

(1) According to a first aspect of the present disclosure, An apparatus is provided. the apparatus comprises: a first acquisition unit acquiring first information, the first information being unique information of a moving object, the moving object being capable of moving by unmanned driving; a second acquisition unit acquiring second information, the second information being unique information of a part to be assembled to the moving object; and a determination unit determining whether correspondence relationship between the moving object and the part is correct based on the first information and the second information.

According to this aspect, the correspondence relationship can be confirmed.

(2) In the above described aspect, the first acquisition unit may acquire the first information for each of a plurality of the moving objects, the second acquisition unit may acquire the second information for each of a plurality of the parts, the determination unit may further determine whether the correspondence relationship between each of the moving objects and each of the parts is correct based on information related to order in which each of the first information is acquired and information related to order in which each of the second According to this aspect, the correspondence relationship information is acquired. between the plurality of the moving objects and the plurality of the parts can be effectively confirmed.
(3) In the above-described aspect, the system may further comprise a stopping unit executing, in case the correspondence relationship is determined to be incorrect, at least one of a process of stopping a movement of the moving object of which the correspondence relationship is incorrect and a process of stopping a movement of the part of which the correspondence relationship is incorrect. According to this aspect, it is possible to suppress the moving object and/or part from moving while the correspondence relationship is incorrect, and it is possible to suppress the wrong part from being assembled to the moving object.
(4) In the above described aspect, the system may further comprise a notification unit notifying a user of an abnormality when the correspondence relationship is determined to be incorrect. According to this aspect, for example, the user to which the abnormality is reported can investigate the cause of the incorrection of the correspondence relationship and/or take treatment to correct the correspondence relationship.
(5) In the above described aspect, the system may further comprise an instruction unit emitting a correction instruction to make the correspondence relationship correct when the correspondence relationship is determined to be incorrect, wherein the correction instruction may include at least one of a first instruction of instructing the moving object of which the correspondence relationship is incorrect to move such that the correspondence relationship becomes correct, and a second instruction of instructing a device configured to be able to change order of the part of which the correspondence relationship is incorrect to change the order of the part of which the correspondence relationship is incorrect such that the correspondence relationship becomes correct. According to this aspect, the correspondence relationship can be made correct by moving the moving object and/or changing order of the part without manual work.

The present disclosure is feasible in various aspects such as, for example, a system, a moving object, a determination method, a program, a non-transitory recording medium storing such a program, a program product, for example, other than the above-described the apparatus. The program product may be, for example, provided as a recording medium including the program, or may be provided as a program product capable of being distributed via a network.

### BRIEF DESCRIPTION OF THE DRAWINGS

FIG. 1 is a conceptual diagram showing the configuration of the system according to the first embodiment;

FIG. 2 is a conceptual diagram illustrating the correspondence relationship between each of the vehicles and each of the parts;

FIG. 3 is a block diagram showing the configuration of the system according to the first embodiment;

FIG. 4 is a flowchart showing a processing procedure for running control of the vehicle 100 in the first embodiment;

FIG. 5 is a flowchart of a determination process in the first embodiment;

FIG. 6 is a flowchart of a determination process in the second embodiment;

FIG. 7 is a flowchart of a determination process in the third embodiment;

FIG. 8 is a block diagram showing the configuration of the system according to the second embodiment;

FIG. 9 is a flowchart showing a processing procedure for running control of the vehicle 100 in the fourth embodiment.

### DETAILED DESCRIPTION

### A. First Embodiment

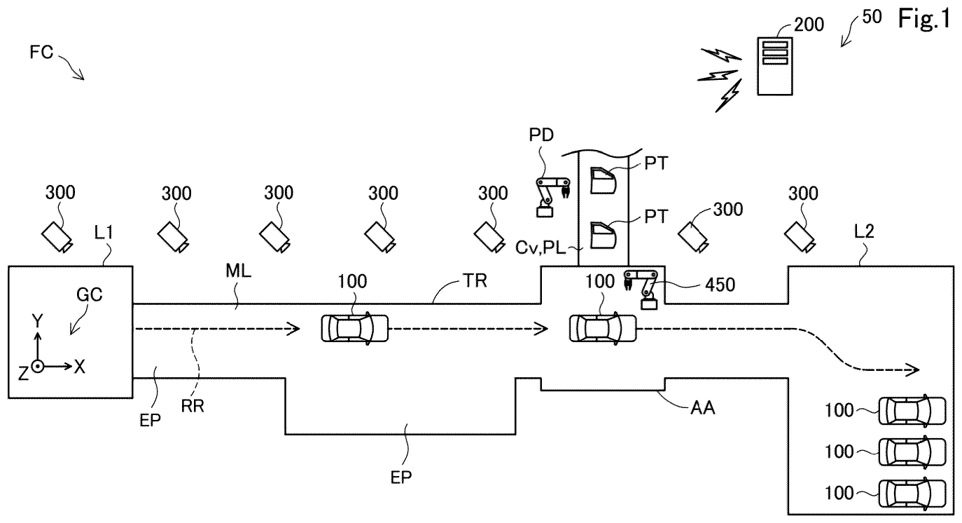

FIG. 1 is a conceptual diagram showing the configuration of a system 50 according to the first embodiment. The system 50 comprises one or more vehicle 100 as a moving object, a server 200, and one or more external sensors 300. The server 200 in the first embodiment corresponds to the “apparatus” in the present disclosure.

In the present disclosure, the “moving object” means an object capable of moving, and is a vehicle or an electric vertical takeoff and landing aircraft (so-called flying-automobile), for example. The vehicle may be a vehicle to run with a wheel or may be a vehicle to run with a continuous track, and may be a passenger car, a truck, a bus, a two-wheel vehicle, a four-wheel vehicle, a combat vehicle, or a construction vehicle, for example. The vehicle includes a battery electric vehicle (BEV), a gasoline automobile, a hybrid automobile, and a fuel cell automobile. When the moving object is other than a vehicle, the term “vehicle” or “car” in the present disclosure is replaceable with a “moving object” as appropriate, and the term “run” is replaceable with “move” as appropriate.

The vehicle 100 is configured to be capable of running by unmanned driving. The “unmanned driving” means driving independent of running operation by a passenger. The running operation means operation relating to at least one of “run,” “turn,” and “stop” of the vehicle 100. The unmanned driving is realized by automatic remote control or manual remote control using a device provided outside the vehicle 100 or by autonomous control by the vehicle 100. A passenger not involved in running operation may be on-board a vehicle running by the unmanned driving. The passenger not involved in running operation includes a person simply sitting in a seat of the vehicle 100 and a person doing work such as assembly, inspection, or operation of switches different from running operation while on-board the vehicle 100. Driving by running operation by a passenger may also be called “manned driving.”In the present specification, the “remote control” includes “complete remote control” by which all motions of the vehicle 100 are completely determined from outside the vehicle 100, and “partial remote control” by which some of the motions of the vehicle 100 are determined from outside the vehicle 100. The “autonomous control” includes “complete autonomous control” by which the vehicle 100 controls a motion of the vehicle 100 autonomously without receiving any information from a device outside the vehicle 100, and “partial autonomous control” by which the vehicle 100 controls a motion of the vehicle 100 autonomously using information received from a device outside the vehicle 100.

The vehicle 100 is simply required to have a configuration to become movable by unmanned driving. The vehicle 100 may embodied as a platform having the following configuration, for example. The vehicle 100 is simply required to include at least actuators and a controller. More specifically, in order to fulfill three functions including “run,” “turn,” and “stop” by unmanned driving, the actuators may include a driving device, a steering device and a braking device. The actuators are controlled by the controller that controls running of the vehicle 100. In order for the vehicle 100 to acquire information from outside for unmanned driving, the vehicle 100 is simply required to include the communication device further. Specifically, the vehicle 100 to become movable by unmanned driving is not required to be equipped with at least some of interior components such as a driver's seat and a dashboard, is not required to be equipped with at least some of exterior components such as a bumper and a fender or is not required to be equipped with a bodyshell. In such cases, a remaining component such as a bodyshell may be mounted on the vehicle 100 before the vehicle 100 is shipped from a factory, or a remaining component such as a bodyshell may be mounted on the vehicle 100 after the vehicle 100 is shipped from a factory while the remaining component such as a bodyshell is not mounted on the vehicle 100. Each of components may be mounted on the vehicle 100 from any direction such as from above, from below, from the front, from the back, from the right, or from the left. Alternatively, these components may be mounted from the same direction or from respective different directions. The location determination for the platform may be performed in the same way as for the vehicle 100 in the first embodiments.

In the present embodiment, the system 50 is used in a factory FC of manufacturing the vehicle 100. The reference coordinate system in the factory FC is a global coordinate system GC. Location in the factory FC can be expressed by X, Y, and Z coordinates in the global coordinate system GC. The vehicle 100 is moved by the unmanned driving in the factory FC from the first place L1 to the second place L2 through the track TR on which the vehicle 100 is capable of traveling.

In the factory FC, a plurality of external sensors 300 are provided along the track TR. The external sensor 300 is a sensor located outside the vehicle 100. The external sensor 300 is configured by a camera. The camera as the external sensor 300 captures images of the vehicle 100 and outputs the captured images as detection results. The external sensor 300 includes a communication device (not shown), and is capable of communication with other devices, such as the server 200, via wired or wireless communication. The position of each external sensor 300 in the factory FC is adjusted in advance.

The factory FC has a manufacturing line ML and a parts line PL. The manufacturing line ML and the parts line PL merge in the assembly area AA. The manufacturing line ML is used to transport the vehicle 100 by the unmanned driving. In the present embodiment, a portion of the track TR corresponds to the manufacturing line ML. The parts line PL is used to transport a plurality of the parts PT. In the parts line PL, each of the parts PT to be assembled to each of the vehicles 100 to be manufactured in the factory FC flows. In the present embodiment, the conveyor unit Cv for transporting the parts PT toward the assembly area AA corresponds to the parts line PL. The parts line PL may be configured to be capable of transporting the parts PT to the assembly area AA in order. In other embodiments, the parts line PL may be a line that uses a hanger for hanging and moving the parts PT, or may be a line that uses an automated guided vehicle (AGV) for transporting the parts PT. In the assembly area AA, the assembly of the part PT to the vehicle 100 is performed. In the present embodiment, the assembly in the assembly area AA is performed by the assembly robot 450. The assembly robot 450 is an example of a device to assemble the parts PT to the vehicle 100.

In the present embodiment, the part processing device PD is disposed in a vicinity of the parts line PL. The part processing device PD is configured by the robot, for example. The part processing device PD is configured so as to be capable of changing order of the parts PT in the parts line PL. In other embodiments, for example, the assembly robot 450 may function as the part processing device PD.

The vehicle 100 flowing through the manufacturing line ML is capable of vehicle evacuation and vehicle return. The vehicle evacuation means that causing the vehicle 100 to evacuate to an evacuation site EP outside the manufacturing line ML. “Vehicle return” means that the vehicle 100 returns from the evacuation site EP to the manufacturing line ML. The evacuation site EP may be, for example, a track aligned with the manufacturing line ML in widthwise direction of the track TR, a track connected to the manufacturing line ML, or a repair site to repair the vehicle 100. In the present embodiment, the vehicle evacuation and the vehicle return are realized by running by the unmanned driving of the vehicle 100. In other embodiments, the vehicle evacuation or the vehicle return may be realized, for example, by the running operation by a worker, by transportation using wheels of the vehicle 100 by a worker or the robot, or by transportation without wheels. The vehicle 100 is configured to be movable by the unmanned driving so that the vehicle 100 can be easily evacuated and returned by driving the vehicle 100 or transporting the vehicle 100 on the track TR. The vehicle evacuation may be performed, for example, to evacuate the vehicle 100 having a defect. The vehicle return may be performed, for example, to return the vehicle 100 where the defect has been repaired.

On the manufacturing line ML, vehicle order change can be performed. The vehicle order change is order change between the vehicles 100. The vehicle order change includes order change using the evacuation of the vehicle 100 and order change without evacuation of the vehicle 100. The order change using evacuation of the vehicle 100 is realized by the vehicle evacuation or the vehicle return. The order change without the evacuation of the vehicle 100 can be realized by overtaking between the vehicle 100 in the manufacturing line ML.

The parts PT flowing through the parts line PL are capable of the part evacuate and part return in the same manner as the vehicle 100. “Part evacuation” means causing the part PT to evacuate to the outside of the parts line PL. “Part Return” means that the part PT is returned on the parts line PL. Furthermore, the part order change can be performed. The part order change is order change between the parts PT flowing through the parts line PL. The part order change includes order change using the evacuation of part PT and order change without the evacuation of part PT, in the same manner as the vehicle order change. The part evacuation, the part return, and the part order change may be performed by, for example, the part processing device PD, or a worker. For example, the conveyor unit Cv, the hanger, or the AGV used in the parts line PL may be configured as a device that can execute the part evacuation, the part return, and/or the part order change.

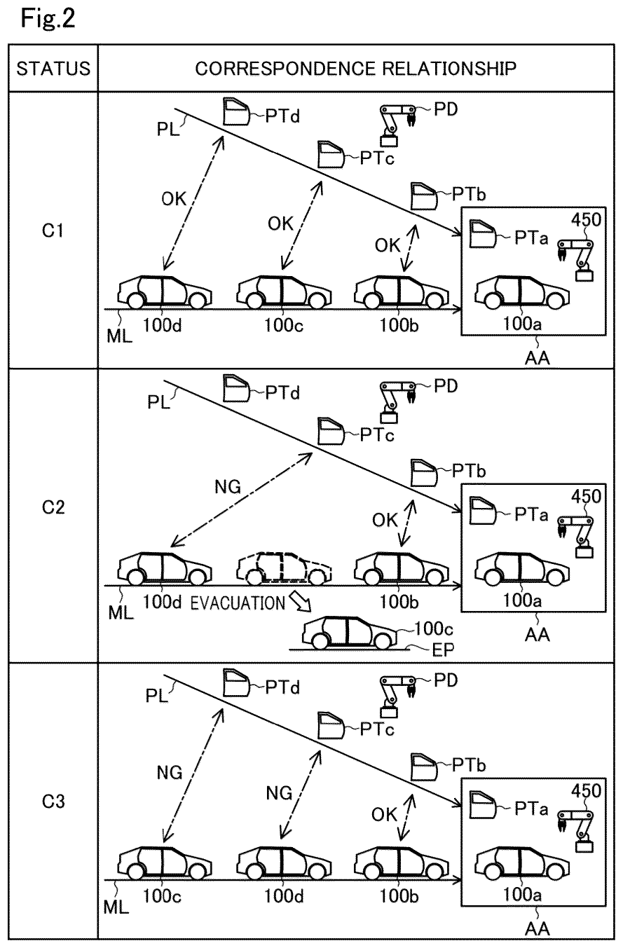

FIG. 2 is a conceptual diagram illustrating correspondence relationship between each of the vehicles 100 in the manufacturing line ML and each of the parts PT in the parts line PL. The parts PTa, PTb, PTc, and PTd shown in FIG. 2 are parts PT that should be assembled into the vehicle 100a, 100b, 100c and, 100d, respectively. In the example of FIG. 2, the fact the parts PTa, PTb, PTc, and PTd are assembled to the vehicle 100a, 100b, 100c, and 100d respectively means that each assembly in the assembly area AA is correctly performed.

In the state C1 shown in FIG. 2, the correspondence relationship between each of the vehicles 100 and each of the parts PT is correct. Specifically, the order of each vehicle 100 corresponds to the order of each part PT to be assembled to each the vehicle 100. The correspondence relationship between the vehicle 100 and the part PT is also simply referred to as “the correspondence relationship”. The correspondence relationship means a correspondence between the order in which each vehicle 100 arrives at the assembly area AA and the order in which each part PT arrives at the assembly area AA. In other words, the correspondence relationship is correspondence between order in which each vehicle 100 flows toward the assembly area AA in the manufacturing line ML and order in which each part PT flows toward the assembly area AA in parts line PL. If the correspondence relationship is correct, in the assembly area AA, by assembling each vehicle 100 and each part PT in the order in which each vehicle 100 and each part PT arrive at the assembly area AA, each assembly is performed correctly. On the other hand, in the state C2 and the state C3 shown in FIG. 2, the correspondence relationship is incorrect. Specifically, in the state C2, the vehicle 100d and the part PTc correspond due to the fact that the vehicle 100c was evacuated. In the state C3, the part PTc corresponds to the vehicle 100d and the part PTd corresponds to the vehicle 100c due to replacement of the vehicle 100c with the vehicle 100d or the part PTc with the part PTd. In the state C2 and the state C3, at least one of the vehicles 100 are assembled with incorrect part PT when each vehicle 100 and each part PT are assembled in the order in which each vehicle 100 and each part PT arrive at the assembly area AA.

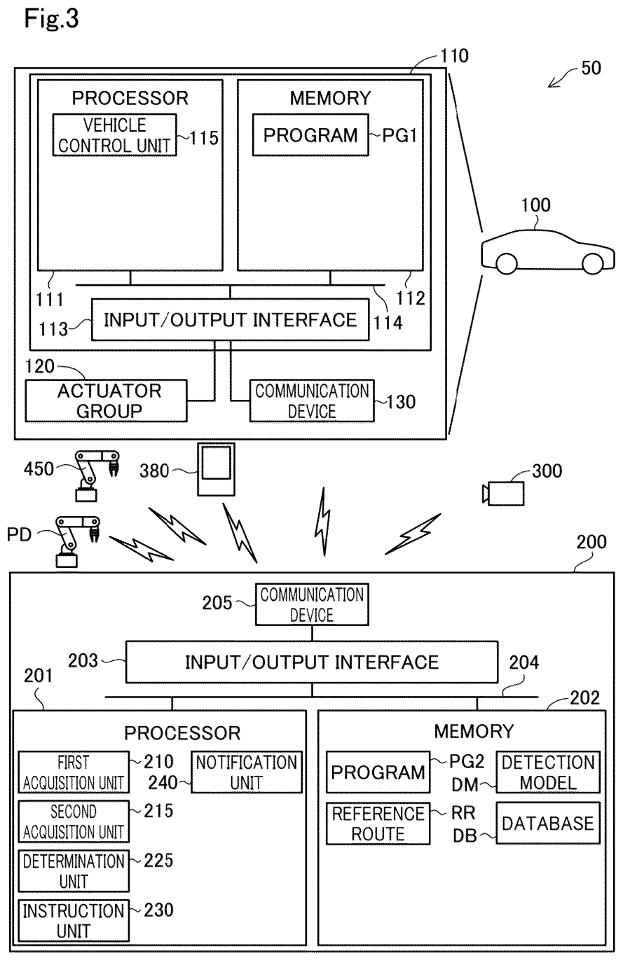

FIG. 3 is a block diagram showing the configuration of the system 50. The vehicle 100 includes a vehicle controller 110 for controlling the various parts of the vehicle 100, an actuator group 120 including one or more actuators driven under the control of the vehicle controller 110, and a communication device 130 for wireless communication with external devices such as the server 200. The actuator group 120 includes an actuator of the driving device for accelerating the vehicle 100, an actuator of the steering device for changing a traveling direction of the vehicle 100, and an actuator of the braking device for decelerating the vehicle 100.

The vehicle controller 110 is configured by a computer including a processor 111, a memory 112, an input/output interface 113, and an internal bus 114. The processor 111, the memory 112, and the input/output interface 113 are connected to be able to communicate in both directions via the internal bus 114. The actuator group 120 and the communication device 130 are connected to the input/output interface 113. The processor 111 executes a program PG1 stored in the memory 112 to implement various functions including a function as a vehicle control unit 115.

The vehicle control unit 115 controls the actuator group 120 to cause the vehicle 100 to run. The vehicle control unit 115 controls the actuator group 120 using a running control signal received from the server 200, thereby causing the vehicle 100 to run. The running control signal is a control signal for enabling the vehicle 100 to run. In the present embodiment, the running control signal includes an acceleration and a steering angle of the vehicle 100 as parameters. In other embodiments, the running control signal may include the speed of the vehicle 100 as a parameter instead of or in addition to the acceleration of the vehicle 100.

The server 200 is configured by a computer comprising a processor 201, a memory 202, an input/output interface 203 and an internal bus 204. The processor 201, the memory 202, and the input/output interface 203 are connected to be able to communicate in both directions via the internal bus 204. The communication device 205 for communication with various devices outside the server 200 is connected to the input/output interface 203. The communication device 205 can communicate with the vehicle 100 or the terminal device 380 owned by a user via wireless communication, and can communicate with each external sensor 300, the assembly robot 450, or the part processing device PD via wired or wireless communication. Herein, the user refers to a user of the system 50 or the factory FC, such as a manager or a worker of the factory FC, for example. The processor 201 implements various functions, including functions as the first acquisition unit 210, the second acquisition unit 215, the determination unit 225, the instruction unit 230, and the notification unit 240, by executing the program PG2 stored in the memory 202. The instruction unit 230 and the notification unit 240 correspond to the outputting unit. The outputting unit outputs information according to the determination result made by the determination unit 225 on the correspondence relationship. Determination result is described later.

The first acquisition unit 210 acquires first information. The first information is unique information of the vehicle 100. The unique information of the vehicle 100 is information for distinguishing one vehicle 100 from another based on a predetermined criterion. As the first information, for example, an identification number of the vehicle 100 or the specification information of the vehicle 100 can be used. The identification number of the vehicle 100 is, for example, a vehicle identification number (VIN) or a serial number. The vehicle identification number and the serial number are information by which each vehicle 100 can be identified uniquely. In this case, each vehicle 100 can be uniquely identified by the first information. The specification information of the vehicle 100 is various information relating to the specification of the vehicle 100, for example, information representing a vehicle type of the vehicle 100, information representing color of the vehicle 100 and information representing a grade of the vehicle 100. When using the specification as the first information, the vehicle 100 can be identified for each specification by the first information.

In the present embodiment, the first acquisition unit 210, when the vehicle 100 passes a first reference position predetermined in the manufacturing line ML, acquires the first information for the vehicle 100. For example, the first acquisition unit 210 acquires the first information using the external sensor 300 or the first detecting device (not shown) being capable of detecting the first information, the first detecting device provided in the factory FC. The first information may be obtained, for example, based on appearance of the vehicle 100 such as a shape, a pattern, and color of the vehicle 100 and presence or absence of equipment. The first information may be obtained using a two-dimensional code or a RFID (Radio Frequency Identification).

The second acquisition unit 215 acquires second information. The second information is unique information of the part PT. The unique information of the part PT is information for distinguishing the part PT from one another based on a predetermined criterion, similar to the first information. As the second information, for example, an identification number of the part PT or specification information of the part PT can be used. As the second information, for example, the same type of information as the first information may be used, or a type of information different from a type of the first information may be used.

In the present exemplary embodiment, when the part PT passes through a second predetermined reference position in the parts line PL, the second acquisition unit 215 acquires the second information for the part PT. For example, the second acquisition unit 215 acquires the second information by using the external sensor 300 or a second detecting device (not shown) being capable of detecting the second information, the second detecting device being provided in the factory FC. The second information may be obtained based on the appearance of the part PT such as a shape, a pattern, and color of the part PT. The second information may be obtained using a two-dimensional code or a RFID (Radio Frequency Identification, for example.

Based on the first information and the second information, the determination unit 225 determines whether the correspondence relationship between the vehicle 100 and the part PT is correct. In this embodiment, the determination unit 225 determines the correspondence relationship using a database DB stored in the memory 202. In the database DB, first information and second information corresponding to the first information are stored in association with each other.

In the present embodiment, the determination unit 225 determines whether the correspondence relationship between each vehicle 100 and each parts PT is correct based on at least one of a first order information and a second order information. The first order information is information about order in which each first information is acquired. The second order information is information about order in which each second information is acquired. In the present embodiment, the first order information is information representing timing at which each first information is acquired. The second order information is information representing timing at which each second information is acquired. Specifically, the determination unit 225 determines whether or not the correspondence relationship between each vehicle 100 and each parts PT is correct by matching the order in which each first information is acquired with the order in which each second information is acquired.

The instruction unit 230 according to the present embodiment functions as a remote control unit appropriately. The remote control unit generates the driving control signal and transmits the driving control signal to the vehicle 100, thereby causing the vehicle 100 to drive by remote control. In other words, the instruction unit 230 issues a remote instruction to the vehicle 100 to cause the vehicle 100 to run by remote control. Hereinafter, issuing of an instruction is also referred to as “executing an instruction.”

The instruction unit 230 emits a correction instruction. The correction instruction is an instruction that is executed when the correspondence relationship is determined to be incorrect, and is an instruction to make the correspondence relationship correct. The correction instruction includes at least one of a first instruction and a second instruction. The first instruction is to instruct the vehicle 100 to move to the correct the correspondence relationship. The second instruction is to instruct a device configured to be capable of changing order of parts PT having incorrect correspondence relationship to change order of parts PT so that the correspondence relationship becomes correct. In the present embodiment, the correction instruction includes the first instruction among the first instruction and the second instruction.

In the present embodiment, the first instruction includes an instruction for executing the order change. Specifically, in the first instruction, the instruction unit 230 generates a running control signal for performing evacuation, return and/or overtaking of the vehicle 100 and transmits the generated the running control signal to the vehicle 100 to be instructed. When executing the first instruction, the instruction unit 230 generates the running control signal for the first instruction using the correction information described below.

The notification unit 240 notifies the user of abnormality when the correspondence relationship is determined to be incorrect. When notifying an abnormality, the notification unit 240 may, for example, notify the user of error information regarding that the correspondence relationship is incorrect. The notification unit 240 may execute the notification using, for example, the terminal device 380 or an output device (not shown) provided in the factory FC. Specifically, the notification unit 240 may perform notification by sending a control signal for causing the terminal device 380 to output visual information or audio information to the terminal device 380, for example. Similarly, the notification unit 240 may execute the notification by sending a control signal to the output device. The output device may be, for example, a display device, a warning light, a speaker or an alarm. The display device and the warning light outputs visual information. The speaker and the alarm outputs audio information.

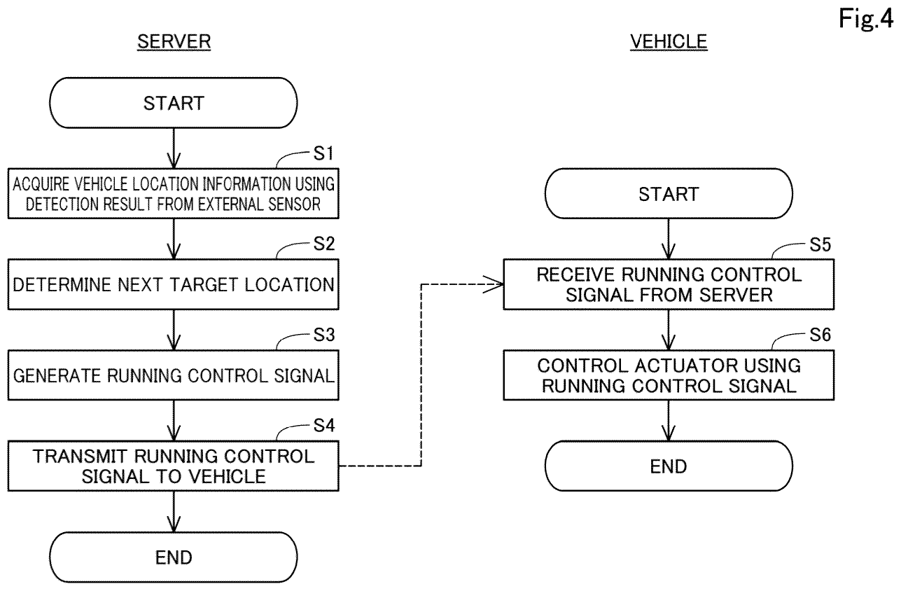

FIG. 4 is a flowchart showing a processing procedure for running control of the vehicle 100 in the first embodiment. In the process shown in FIG. 4, the processor 201 of the server 200 functions as the remote control part by executing the program PG2. The processor 111 of the vehicle 100 functions as the vehicle control unit 115 by executing the program PG1.

In step S1, the processor 201 of the server 200 acquires vehicle location information using detection result output from the external sensor 300. The vehicle location information is locational information as a basis for generating a running control signal. In the present embodiment, the vehicle location information includes the location and orientation of the vehicle 100 in the global coordinate system GC. Specifically, in step S1, the processor 201 acquires the vehicle location information using the captured image acquired from the camera as the external sensor 300.

More specifically, in step S1, the processor 201 for example, determines the outer shape of the vehicle 100 from the captured image, calculates the coordinates of a positioning point of the vehicle 100 in a coordinate system of the captured image, namely, in a local coordinate system, and converts the calculated coordinates to coordinates in the global coordinate system, thereby acquiring the location of the vehicle 100. The outer shape of the vehicle 100 in the captured image may be detected by inputting the captured image to a detection model DM using artificial intelligence, for example. The detection model DM is prepared in the system 50 or outside the system 50, for example. The detection model is stored in advance in the memory 202 of the server 200, for example. An example of the detection model DM is a learned machine learning model that was learned so as to realize either semantic segmentation or instance segmentation. For example, a convolution neural network (CNN) learned through supervised learning using a learning dataset is applicable as this machine learning model. The learning dataset contains a plurality of training images including the vehicle 100, and a label showing whether each region in the training image is a region indicating the vehicle 100 or a region indicating a subject other than the vehicle 100, for example. In training the CNN, a parameter for the CNN is preferably updated through backpropagation in such a manner as to reduce error between output result obtained by the detection model DM and the label. The processor 201 can acquire the orientation of the vehicle 100 through estimation based on the direction of a motion vector of the vehicle 100 detected from change in location of a feature point of the vehicle 100 between frames of the captured images using optical flow process, for example.

In step S2, the processor 201 of the server 200 determines a target location to which the vehicle 100 is to move next. In the present embodiment, the target location is expressed by X, Y, and Z coordinates in the global coordinate system GC. The memory 202 of the server 200 contains a reference route RR stored in advance as a route along which the vehicle 100 is to run. The route is expressed by a node indicating a departure place, a node indicating a way point, a node indicating a destination, and a link connecting nodes to each other. The processor 201 determines the target location to which the vehicle 100 is to move next using the vehicle location information and the reference route RR. The processor 201 determines the target location on the reference route RR ahead of a current location of the vehicle 100.

In step S3, the processor 201 of the server 200 generates a running control signal for causing the vehicle 100 to run toward the determined target location. The processor 201 calculates a running speed of the vehicle 100 from transition of the location of the vehicle 100 and makes comparison between the calculated running speed and a target speed of the vehicle 100 determined in advance. If the running speed is lower than the target speed, the processor 201 generally determines an acceleration in such a manner as to accelerate the vehicle 100. If the running speed is higher than the target speed as, the processor 201 generally determines an acceleration in such a manner as to decelerate the vehicle 100. If the vehicle 100 is on the reference route, processor 201 determines a steering angle and an acceleration in such a manner as to prevent the vehicle 100 from deviating from the reference route RR. If the vehicle 100 is not on the reference route RR, in other words, if the vehicle 100 deviates from the reference route RR, the server 200 determines a steering angle and an acceleration in such a manner as to return the vehicle 100 to the reference route RR.

In the present embodiment, when generating the running control signal for the first instruction in S1-S3, the processor 201 generates the running control signal using the correction information as described above. The correction information are used to generate the running control signal so that the correspondence relationship becomes correct. The correction information may include, for example, information representing a new target location, information representing a new path, and information for correcting each parameter included in the running control signal.

In step S4, the processor 201 of the server 200 transmits the generated running control signal to the vehicle 100. The processor 201 repeats the acquisition of vehicle location information, the determination of a target location, the generation of a running control signal, the transmission of the running control signal, and others in a predetermined cycle.

In step S5, the processor 111 of the vehicle 100 receives the running control signal transmitted from the server 200. In step S6, the processor 111 of the vehicle 100 controls the actuator group 120 of the vehicle 100 using the received running control signal, thereby causing the vehicle 100 to run at the acceleration and the steering angle indicated by the running control signal. The processor 111 repeats the reception of a running control signal and the control over the actuator group 120 in a predetermined cycle. According to the system 50 in the present embodiment, it becomes possible to move the vehicle 100 without using a transport unit such as a crane or a conveyor.

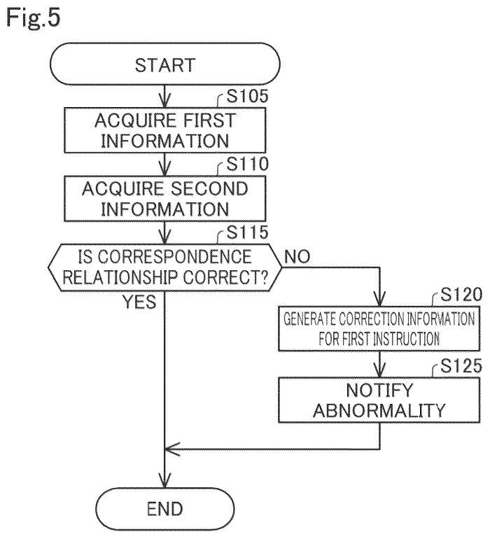

FIG. 5 is a flowchart of a determination process for realizing the determination method in the present embodiment. While the running control in FIG. 4 is being performed, the processor 201, for example, performs the determination process in FIG. 5 at predetermined temporal intervals.

In S105, the first acquisition unit 210 acquires the first information for each vehicle 100. As a result, the first order information is acquired. In S110, the second acquisition unit 215 acquires the second information for each part PT. As a result, the second order information is acquired. In S115, the determination unit 225 determines whether or not the correspondence relationship is correct based on each information acquired by S105 and S110 and each order information, i.e., the timing at which each first information is acquired and the timing at which each second information is acquired. If the correspondence relationship is incorrect in S115, in S120, the instruction unit 230 generates a correction information for the first instruction. In S125 of FIG. 5, the notification unit 240 notifies the user of an abnormality. If S120 is performed, in S1-S3 of FIG. 4, the instruction unit 230 generates a running control signal using the correction information generated in S120. In this case, in S4, the instruction unit 230 executes the first instruction by sending the generated running control signal using the correction data to the vehicle 100.

Hereinafter, a specific example of the first instruction will be described with reference to FIG. 2. In the state C2, for example, in order to make the correspondence relationship correct, the vehicle return is executed to return the vehicle 100c to the manufacturing line ML. In this situation, the instruction unit 230 generates a running control signal using correction information to cause the vehicle 100c to return to the manufacturing line ML and transmits the generated running control signal to the vehicle 100c. In the state C3, for example, the vehicle order change is executed to swap the order of the vehicle 100c and the vehicle 100d. In this case, the instruction unit 230 generates a running control signal to make the speed of vehicle 100c greater than the speed of vehicle 100d, such as a running control signal to make vehicle 100d run at a slower speed and/or a running control signal to make vehicle 100c run at a faster speed, and transmits the generated running control signal to vehicle 100d and vehicle 100c.

According to the server 200 in the present embodiment described above, it is determined whether or not the correspondence relationship between the vehicle 100 and the part PT is correct based on the first information that is the unique information of the vehicle 100 and the second information that is the unique information of the part PT. Here, in the present embodiment, the vehicle 100 is transported to the assembly area AA using the unmanned driving, so compared to the case where the unmanned driving is not used, for example, the vehicle evacuation, the vehicle return, and/or the vehicle order change can be more easily executed in accordance with malfunction of the vehicle 100 on the manufacturing line ML and/or production status of the vehicle 100 in the factory FC. On the other hand, the vehicle evacuation, the vehicle return, and the vehicle order change can cause incorrection of the correspondence relationship. In the present embodiment, the correspondence relationship can be checked under conditions where the incorrection of the correspondence relationship may occur due to the vehicle evacuation, the vehicle return, and/or the vehicle order change. As a result, for example, in the assembly area AA, it is possible to effectively suppress the incorrect part PT from being assembled to the vehicle 100, and it is possible to increase the possibility that the assembly in the assembly area AA is properly performed.

In the present embodiment, since, based on the first order information and the second order information, the vehicle 100 and the parts PT is determined whether the correspondence relationship is correct, it can be effectively confirmed the correspondence relationship between the plurality of the vehicles 100 and the plurality of the parts PT.

In the present embodiment, abnormality is notified to the user when the correspondence relationship is determined to be incorrect. Therefore, for example, the user to which an abnormality is reported can investigate the cause of the incorrection of the correspondence relationship and/or take a treatment to correct the correspondence relationship.

In the present embodiment, when the correspondence relationship is determined to be incorrect, the first instruction is performed to the vehicle 100. Thus, for example, the correspondence relationship can be corrected by moving the vehicle 100 without manual operation of the user.

### B. Second Embodiment

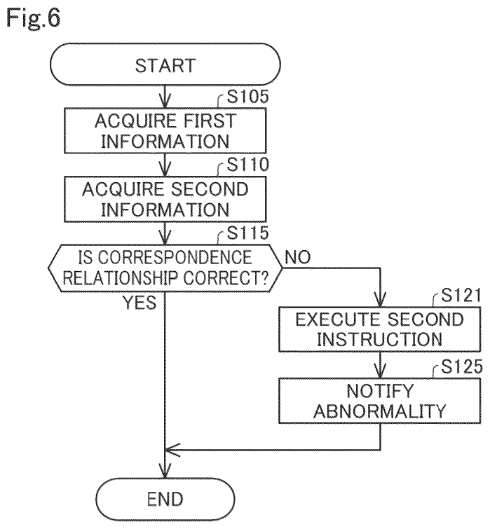

FIG. 6 is a flowchart of a determination process for realizing the determination method in the second embodiment. In the present embodiment, unlike the first embodiment, the instruction unit 230 performs the second instruction instead of the first instruction as the correction instruction. Other configurations, unless otherwise described, are same as configurations in the first embodiment.

In S121 of FIG. 6, the instruction unit 230 performs the second instruction. In this embodiment, the second instruction is performed to the part processing device PD as a device that is configured to be capable of changing order of the part PT having the incorrect correspondence relationship. The second instruction, for example, includes an instruction for performing a part order change. In the second instruction according to the present embodiment, the instruction unit 230 generates a control signal for executing evacuation, return and/of overtaking of the part PT, and transmits the generated control signal to the part processing device PD.

Hereinafter, a specific example of the second instruction will be described with reference to FIG. 2. In the state C2, for example, in order to make the correspondence relationship correct, the part evacuation to evacuate the part PTc that should be assembled to the evacuated vehicle 100c is executed. In the state C3, for example, the part order change to replace the order of the part PTc and the part PTd is executed. In this case, the instruction unit 230 generates, for example, a control signal for moving the part PTd forward of the part PTc on the parts line PL and/or a control signal for moving the part PTc behind the part PTd, and transmits the generated control signal to the part processing device PD. Such part order change may be accompanied by the part evacuation and/or the part return.

According to the server 200 in the above-described embodiment, when the correspondence relationship is determined to be incorrect, the second instruction is executed. Therefore, the correspondence relationship can be correct by changing the order of the parts PT without manual work.

In other embodiments, the instruction unit 230 may execute both the first instruction and the second instruction to make the correspondence relationship correct.

In other embodiments, the instruction unit 230 may execute the third instruction as the correction instruction. The third instruction is executed to the user such as the administrator or an operator being capable of changing order of the part PT. In this case, the instruction unit 230 may execute the third instruction instead of the second instruction, for example, in S121 of FIG. 6. According to this aspect, the correspondence relationship can be corrected by moving the part PT manually.

### C. Third Embodiment

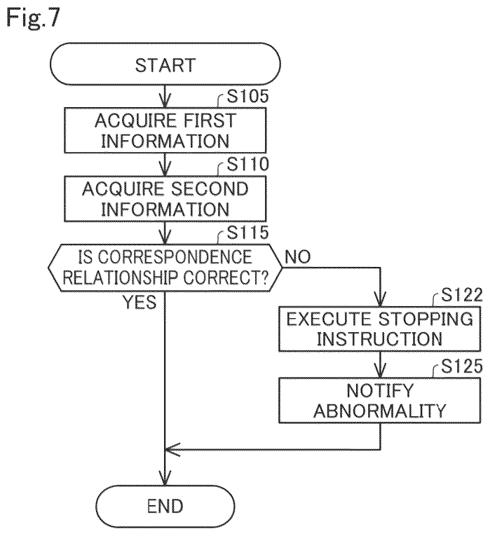

FIG. 7 is a flowchart of a determination process for realizing the determination method in the third embodiment. In the present embodiment, unlike the first embodiment, the instruction unit 230 functions as a stopping unit. The stopping unit corresponds to the outputting unit, similarly to the instruction unit 230 and the notification unit 240. The stopping unit in the present embodiment executes at least one of vehicle stop and part stop when the correspondence relationship is determined to be incorrect. Vehicle stop means that a process of stopping movement of the vehicle 100 having the incorrect correspondence relationship on the manufacturing line ML. Part stop means that a process of stopping movement of the part PT having the incorrect correspondence relationship on the parts line PL. The stopping unit in the present embodiment executes the vehicle stop among the vehicle stop and the part stop. Note that the vehicle stop includes not only stopping the movement of the moving vehicle 100 but also continuing to stop the movement of the vehicle 100 that is temporarily stopping the movement. Part stop includes not only stopping the movement of the moving part PT but also continuing to stop the movement of the part PT that is temporarily stopping the movement. Other configurations, unless otherwise described, are the same as configurations of the first embodiment.

In S122 of FIG. 7, the instruction unit 230 functions as the stopping unit, and executes stopping instruction. Specifically, in S122, the instruction unit 230 generates a running control signal to stop the vehicle 100 and transmits the generated running control signal to the vehicle 100. In other embodiments, the instruction unit 230 may stop the vehicle 100 by stopping transmitting the running control signal to the vehicle 100. The vehicle stop may be executed at least for the vehicle 100 having an incorrect correspondence relationship among the vehicles 100. Thus, for example, the vehicle stop may be performed for all the vehicle 100 on the manufacturing line ML. The vehicle stop may be performed, for example, for each vehicle 100 behind the vehicle 100 with the incorrect correspondence.

According to the server 200 in the third embodiment described above, when the correspondence relationship is determined to be incorrect, the vehicle stop is executed. Therefore, it is suppressed that the vehicle 100 moves toward the assembly area AA while the correspondence relationship remains incorrect, and that incorrect part PT is assembled to be the vehicle 100. Furthermore, for example, while the movement of the vehicle 100 is stopped, a manager or a worker can investigate a cause of the incorrect correspondence relationship and/or perform a treatment to correct the correspondence relationship.

In other embodiments, the part stop may be performed in addition to or in place of the vehicle stop. The part stop may be performed at least for parts PT having the incorrect correspondence relationship among the parts PT, similar to the vehicle stop. In the part stop, The instruction unit 230, for example, may transmit a control signal to stop conveyance of the part PT by the conveyor unit Cv, the hanger, or the AGV to the conveyor unit Cv the like. According to this aspect, it is suppressed that the part PT moves toward the assembly area AA while the correspondence relationship remains incorrect, and that incorrect part PT is assembled to be the vehicle 100. Furthermore, for example, while the movement of the part PT is stopped, a manager or a worker can investigate a cause of the incorrect correspondence relationship and/or perform a treatment to correct the correspondence relationship.

### D. Fourth Embodiment

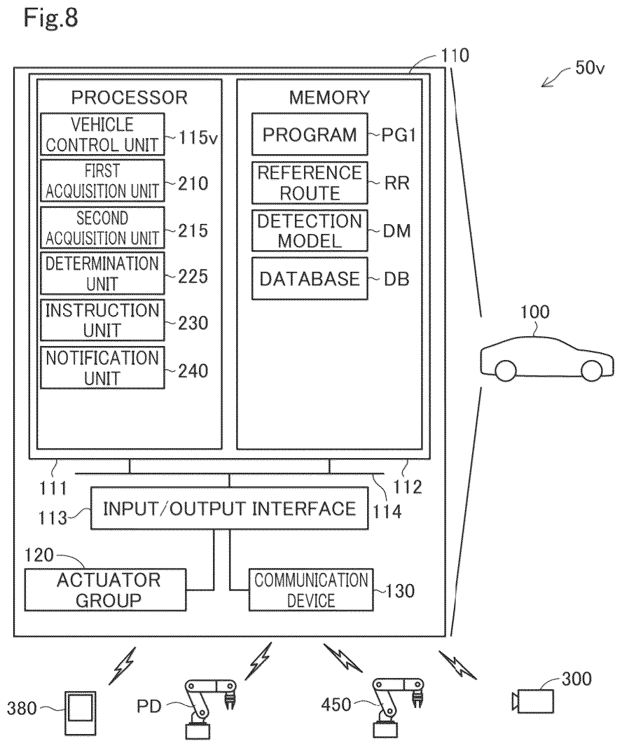

FIG. 8 is a block diagram showing the configuration of the system 50v according to the fourth embodiment. Unlike the first embodiment, the system 50v in the present embodiment does not include the server 200. The vehicle in the present embodiment can be driven by the autonomous control of the vehicle. Other configurations, unless otherwise described, are the same as configurations of the first embodiment. Since the configuration of the vehicle in the present embodiment is the same as in the first embodiment, the vehicle in the present embodiment is denoted as vehicle 100 for convenience.

In the present embodiment, the communication device 130 of the vehicle 100 can communicate with the external sensor 300 and the terminal device 380. The processor 111 of the vehicle controller 110 functions as the vehicle control unit 115v, the first acquisition unit 210, the second acquisition unit 215, the instruction unit 230, and the notification unit 240 by executing the program PG2 stored in the memory 112. The vehicle control unit 115v can cause the vehicle 100 to run under autonomous control by controlling the actuator group 120 using the running control signal generated by the vehicle 100. In addition to the program PG1, the memory 112 stores the reference route RR, the detection model DM, and the database DB. The vehicle controller 110 in the fourth embodiment corresponds to the “apparatus” in the present disclosure.

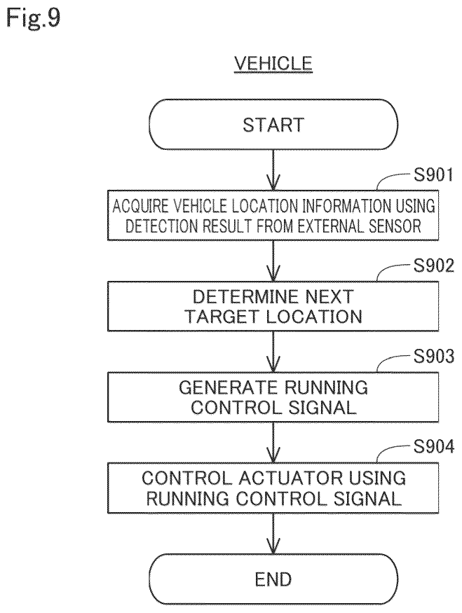

FIG. 9 is a flowchart showing a processing procedure for running control of the vehicle 100 in the fourth embodiment. In the process in FIG. 9, the processor 111 of the vehicle 100 functions as the vehicle control unit 115v by executing the program PG1.

In step S901, the processor 111 of the vehicle controller 110 acquires vehicle location information using detection result output from the camera as the external sensor 300. In step S902, the processor 111 determines a target location to which the vehicle 100 is to move next. In step S903, the processor 111 generates a running control signal for causing the vehicle 100 to run to the determined target location. In step S904, the processor 111 controls the actuator group 120 using the generated running control signal, thereby causing the vehicle 100 to run by following a parameter indicated by the running control signal. The processor 111 repeats the acquisition of vehicle location information, the determination of a target location, the generation of a running control signal, and the control over the actuator in a predetermined cycle. According to the system 50v in the present embodiment, it is possible to cause the vehicle 100 to run by autonomous control without controlling the vehicle 100 remotely using the server 200.

The determination process of the vehicle 100 according to the present embodiment is realized by the same determination process as shown in FIG. 5. However, in the present embodiment, the determination process is executed by the processor 111 of the vehicle controller 110, not the processor 201 of the server 200, for example, at predetermined time intervals. In the present embodiment, the first instruction is performed by the instruction unit 230 of the vehicle 100 instead of the server 200. When executing the first instruction for itself, the vehicle 100 controls its own actuator group 120 using the running control signal by generating and outputting the running control signal for the first instruction. The vehicle 100 may perform the first instruction to the preceding vehicle preceding the vehicle 100 and/or the following vehicle following the vehicle 100. In such cases, the vehicle 100 may not transmit the running control signal to the preceding vehicle and the following the vehicle, and may, for example, transmit a signal that is a trigger for generating the running control signal and/or the correction information to the preceding the vehicle and the succeeding the vehicle.

According to the vehicle 100 in the present embodiment described above, similarly to the server 200 in the first embodiment, the correspondence relationship can be confirmed.

### E. Other Embodiments

(E1) In each of the above-described embodiments, the determination unit 225 determines whether or not the correspondence relationship is correct based on the first order information and the second order information in addition to the first information and the second information. In contrast, the determination unit 225 may determine whether or not the correspondence relationship is correct without using the first order information and the second order information. For example, using the external sensor 300, when each of the first information is acquired at a plurality of points at the same time and each of the second information is acquired at a plurality of points at the same time, the determination unit 225 may determine whether the correspondence relationship is correct or not based on the information representing the position of each of the vehicle 100 on the manufacturing line ML at the timing when each the first information is acquired and the information representing the position of each of the parts PT on the parts line PL at the timing when each the second information is acquired. Furthermore, for example, when determining whether the correspondence relationship between one vehicle 100 on the manufacturing line ML and one part PT on the parts line PL is correct, the determination unit 225 may not use the first order information and the second order information.

(E2) In each of the above-described embodiments, the server 200 or the vehicle 100 is provided with the notification unit 240. In contrast, the server 200 and the vehicle may not include the notification unit 240.

(E3) In each of the above-described embodiments, the instruction unit 230 executes the correction instruction, but may not execute the correction instruction. In this case, for example, without the correction instruction being executed, the notification by the notification unit 240 may be executed, the determination result by the determination unit 225 may be output to the output device, and/or the determination result by the determination unit 225 may be output to the terminal device 380.

(E4) In each of the above-described embodiments, the external sensor 300 is not limited to the camera but may be the distance measuring device, for example. The distance measuring device is a light detection and ranging (LiDAR) device, for example. In this case, detection result output from the external sensor 300 may be three-dimensional point cloud data representing the vehicle 100. The server 200 and the vehicle 100 may acquire the vehicle location information through template matching using the three-dimensional point cloud data as the detection result and reference point cloud data, for example.

(E5) In the above-described first embodiment, the server 200 performs the processing from acquisition of vehicle location information to generation of a running control signal. By contrast, the vehicle 100 may perform at least part of the processing from acquisition of vehicle location information to generation of a running control signal. For example, embodiments (1) to (3) described below are applicable, for example.
(1) The server 200 may acquire vehicle location information, determine a target location to which the vehicle 100 is to move next, and generate a route from a current location of the vehicle 100 indicated by the acquired vehicle location information to the target location. The server 200 may generate a route to the target location between the current location and a destination or generate a route to the destination. The server 200 may transmit the generated route to the vehicle 100. The vehicle 100 may generate a running control signal in such a manner as to cause the vehicle 100 to run along the route received from the server 200 and control an actuator using the generated running control signal.
(2) The server 200 may acquire vehicle location information and transmit the acquired vehicle location information to the vehicle 100. The vehicle 100 may determine a target location to which the vehicle 100 is to move next, generate a route from a current location of the vehicle 100 indicated by the received vehicle location information to the target location, generate a running control signal in such a manner as to cause the vehicle 100 to run along the generated route, and control the actuator group 120 using the generated running control signal.
(3) In the foregoing embodiments (1) and (2), an internal sensor may be mounted on the vehicle 100, and detection result output from the internal sensor may be used in at least one of the generation of the route and the generation of the running control signal. The internal sensor is a sensor mounted on the vehicle 100. More specifically, the internal sensor might include a camera, LiDAR, a millimeter wave radar, an ultrasonic wave sensor, a GPS sensor, an acceleration sensor, and a gyroscopic sensor, for example. For example, in the foregoing embodiment (1), the server 200 may acquire detection result from the internal sensor, and in generating the route, may reflect the detection result from the internal sensor in the route. In the foregoing embodiment (1), the vehicle 100 may acquire detection result from the internal sensor, and in generating the running control signal, may reflect the detection result from the internal sensor in the running control signal. In the foregoing embodiment (2), the vehicle 100 may acquire detection result from the internal sensor, and in generating the route, may reflect the detection result from the internal sensor in the route. In the foregoing embodiment (2), the vehicle 100 may acquire detection result from the internal sensor, and in generating the running control signal, may reflect the detection result from the internal sensor in the running control signal.

(E6) In the above-described fourth embodiment, the vehicle 100 may be equipped with an internal sensor, and detection result output from the internal sensor may be used in at least one of generation of a route and generation of a running control signal. For example, the vehicle 100 may acquire detection result from the internal sensor, and in generating the route, may reflect the detection result from the internal sensor in the route. The vehicle 100 may acquire detection result from the internal sensor, and in generating the running control signal, may reflect the detection result from the internal sensor in the running control signal.

(E7) In the above-described fourth embodiment, the vehicle 100 acquires vehicle location information using detection result from the external sensor. By contrast, the vehicle 100 may be equipped with an internal sensor, the vehicle 100 may acquire vehicle location information using detection result from the internal sensor, determine a target location to which the vehicle 100 is to move next, generate a route from a current location of the vehicle 100 indicated by the acquired vehicle location information to the target location, generate a running control signal for running along the generated route, and control an actuator of the vehicle 100 using the generated running control signal. In this case, the vehicle 100 is capable of running without using any detection result from the external sensor 300. The vehicle 100 may acquire target arrival time or traffic congestion information from outside the vehicle 100 and reflect the target arrival time or traffic congestion information in at least one of the route and the running control signal. The functional configuration of the system 50v may be entirely provided at the vehicle 100. Specifically, the processes realized by the system 50v in the present disclosure may be realized by the vehicle 100 alone.

(E8) In the above-described first embodiment, the server 200 automatically generates a running control signal to be transmitted to the vehicle 100. By contrast, the server 200 may generate a running control signal to be transmitted to the vehicle 100 in response to operation by an external operator existing outside the vehicle 100. For example, the external operator may operate an operating device including a display on which a captured image output from the external sensor 300 is displayed, steering, an accelerator pedal, and a brake pedal for operating the vehicle 100 remotely, and a communication device for making communication with the server 200 through wire communication or wireless communication, for example, and the server 200 may generate a running control signal responsive to the operation on the operating device.

(E9) The vehicle 100 may be manufactured by combining a plurality of modules. The module means a unit composed of one or more components grouped according to a configuration or function of the vehicle 100. For example, a platform of the vehicle 100 may be manufactured by combining a front module, a center module and a rear module. The front module constitutes a front part of the platform, the center module constitutes a center part of the platform, and the rear module constitutes a rear part of the platform. The number of the modules constituting the platform is not limited to three but may be equal to or less than two, or equal to or greater than four. In addition to or instead of the platform, any parts of the vehicle 100 different from the platform may be modularized. Various modules may include an arbitrary exterior component such as a bumper or a grill, or an arbitrary interior component such as a seat or a console. Not only the vehicle 100 but also any types of moving object may be manufactured by combining a plurality of modules. Such a module may be manufactured by joining a plurality of components by welding or using a fixture, for example, or may be manufactured by forming at least part of the module integrally as a single component by casting. A process of forming at least part of a module as a single component is also called Giga-casting or Mega-casting. Giga-casting can form each part conventionally formed by joining multiple parts in a moving object as a single component. The front module, the center module, or the rear module described above may be manufactured using Giga-casting, for example.

(E10) A configuration for realizing running of a vehicle by unmanned driving is also called a “Remote Control auto Driving system”. Conveying a vehicle using Remote Control Auto Driving system is also called “self-running conveyance”. Producing the vehicle using self-running conveyance is also called “self-running production”. In self-running production, for example, at least part of the conveyance of vehicles is realized by self-running conveyance in a factory where the vehicle is manufactured.

In each of the embodiments described above, some or all of the functions and processes that are implemented by software may also be implemented by hardware. Further, some or all of the functions and processes that are implemented by hardware may also be implemented by software. Examples of the hardware used to implement various functions in each of the embodiments described above include various circuits, such as integrated circuits and discrete circuits.

The present disclosure is not limited to the embodiments described above and is able to be implemented with various configurations without departing from the spirit thereof. For example, the technical features of any of the embodiment, the examples and the modifications corresponding to the technical features of each of the aspects described in SUMMARY may be replaced or combined appropriately, in order to solve part or all of the problems described above or in order to achieve part or all of the advantageous effects described above. When the technical features are not described as essential features in the present specification, they are able to be deleted as necessary.

What is claimed is:

1. An apparatus comprising:
a first acquisition unit acquiring first information, the first information being unique information of a moving object, the moving object being capable of moving by unmanned driving;
a second acquisition unit acquiring second information, the second information being unique information of a part to be assembled to the moving object; and
a determination unit determining whether correspondence relationship between the moving object and the part is correct based on the first information and the second information.

2. The apparatus according to claim 1, wherein
the first acquisition unit acquires the first information for each of a plurality of the moving objects,
the second acquisition unit acquires the second information for each of a plurality of the parts,
the determination unit further determines whether the correspondence relationship between each of the moving objects and each of the parts is correct based on information related to order in which each of the first information is acquired and information related to order in which each of the second information is acquired.

3. The apparatus according to claim 1, further comprising,
a stopping unit executing, in case the correspondence relationship is determined to be incorrect, at least one of a process of stopping a movement of the moving object of which the correspondence relationship is incorrect and a process of stopping a movement of the part of which the correspondence relationship is incorrect.

4. The apparatus according to claim 1, further comprising,
a notification unit notifying a user of an abnormality when the correspondence relationship is determined to be incorrect.

5. The apparatus according to claim 1, further comprising,
an instruction unit emitting a correction instruction to make the correspondence relationship correct when the correspondence relationship is determined to be incorrect, wherein
the correction instruction includes at least one of:
a first instruction of instructing the moving object of which the correspondence relationship is incorrect to move such that the correspondence relationship becomes correct, and
a second instruction of instructing a device configured to be able to change order of the part of which the correspondence relationship is incorrect to change the order of the part of which the correspondence relationship is incorrect such that the correspondence relationship becomes correct.
